(19) United States
(12) Patent Application Publication
(10) Pub. No.: US 2006/0186575 A1
(43) Pub. Date: Aug. 24, 2006

(54) Multi-material mold and method of making multi-material parts

(76) Inventor: Bill Zvonko Prskalo, Tecumseh (CA)

Correspondence Address: Miller, Canfield, Paddock and Stone P.L.C.;c/o Robert Kelley Roth, Suite 2500, 150 West Jefferson Ave., Detroit, MI, 48226, US

(21) Appl. No.: 11/064,565

(22) Filed: Feb. 24, 2005

(51) Int. Cl. B29C 43/42

(52) U.S. Cl. 264/255; 425/423; 264/328.7; 264/328.8

(57) ABSTRACT

A multi-material mold and method of making multi-material parts is disclosed. The mold comprises a core half having a first station and a second station, a slide, and a cavity half movable with respect to the core half between a first closed position wherein the at least one slide cooperates with the first station of the core half and the cavity half to define a first mold cavity adapted to form a portion of a part, and a second closed position wherein the portion of the part cooperates with the second station of the core half and the cavity half to define a second mold cavity. The slide is slidable between an extended position adapted to hold the portion of the part formed in the first mold cavity to the cavity half, and a retracted position adapted to permit the part to exit the mold. Optical surfaces can be placed on the core half.

### FIELD OF THE INVENTION

This invention relates to improvements in molds, and more particularly to improvements in molds used to make parts comprised of more than one material.

### BACKGROUND OF THE INVENTION

Multi-material molds are used to make parts having more than one material, parts with one material having more than one color, or both more than one material and color. It has been known to make such parts using a multi-station mold. In a two-station mold, a first material is shot into a mold cavity at a first station. The part is attached to one mold half and then moved to a second station where a second material is shot into a mold cavity. Once the molten material has hardened, the part is ejected from the mold and the process repeated.

Two station multi-material molds have found use in various applications, including, for example, automotive lighting such as covers for headlights, brakelights, turn signal lights, etc. Such lighting applications may also have so-called optical components, where the parts have optical properties in addition to being comprised of multiple materials. These optical components are normally formed from an electroform of optical surfaces in the mold. A wide variety of optical mold surfaces are known, including reflective surfaces, retroreflective surfaces, pillow, flute, fresnel and other optical surfaces. More specifically, the electroform is made as an array of pins set as a mold matrix. The resulting matrix is used to make an electroform block (i.e, the optical surface) through an electroplating process. This electroform is subsequently used as an insert tool (generally formed integral with one half of a mold) used in injection molding to make optical and reflective light assemblies. Optic or reflex pins are set in the mold surface to create a plurality of reflective prisms for emitting an array of light from a specified part of the light assembly.

In known two station molds, optical surfaces have been required at both stations. This has been accomplished by having the optical surfaces present on the mold half which moves between stations. Representative examples of these kinds of molds are made by Hallmark Technologies, Inc. of Windsor, Ontario Canada. With these designs, the optical surfaces are positioned on the movable half of the mold. The first material is shot at the first station, the mold half with the optical surface is rotated to a second station, and the second material is shot at the second station. Simultaneously, the first material is shot for a second part at the first station. The part formed at the second station is ejected, and the process repeated until as many parts are made as needed.

Electroforming optical surfaces is relatively expensive and the process of making such surfaces is time consuming. Also, for known multimaterial molds, core pulls and lifters (for undercuts) are required at both stations. It would be desirable to provide a multi-material mold which reduces the amount of electroformed surfaces required on a mold and to provide a mold which reduces the need for core pulls and lifters.

### SUMMARY OF THE INVENTION

In accordance with a first aspect, a multi-material mold comprises a core half having a first station and a second station, a slide, and a cavity half movable with respect to the core half between a first closed position wherein the at least one slide cooperates with the first station of the core half and the cavity half to define a first mold cavity adapted to form a portion of a part, and a second closed position wherein the portion of the part cooperates with the second station of the core half and the cavity half to define a second mold cavity. The slide is slidable between an extended position adapted to hold the portion of the part formed in the first mold cavity to the cavity half, and a retracted position adapted to permit the part to exit the mold. In accordance with another aspect, optical surfaces can be placed on the core half. A method of making an injection molded part using the mold as described is also disclosed.

From the foregoing disclosure and the following more detailed description of various preferred embodiments it will be apparent to those skilled in the art that the present invention provides a significant advance in the technology of molding. Particularly significant in this regard is the potential the invention affords for providing a high quality, low cost mold for making multi-material parts. Additional features and advantages of various preferred embodiments will be better understood in view of the detailed description provided below.

### BRIEF DESCRIPTION OF THE DRAWINGS

FIGS. 1 and 2 shown plan views of a core half and a cavity half, respectively, of a two-station multi-material mold in accordance with a preferred embodiment.

FIG. 3 is a cross section view of a first station of the two station multi-material mold of FIGS. 1-2 shown closed.

FIG. 4 is a cross section view of a second station of the two station multi-material mold of FIGS. 1-2 shown closed.

FIG. 5 shows a cross section of the mold shown closed with an optional lifter provided for parts having undercuts.

It should be understood that the appended drawings are not necessarily to scale, presenting a somewhat simplified representation of various preferred features illustrative of the basic principles of the invention. The specific design features of the mold as disclosed here will be determined in part by the particular intended application and use environment. Certain features of the illustrated embodiments have been enlarged or distorted relative to others to enhance visualization and clear understanding. In particular, thin features may be thickened, for example, for clarity of illustration. All references to direction and position, unless otherwise indicated, refer to the orientation illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the mold disclosed here. The following detailed discussion of various alternative and preferred features and embodiments will illustrate the general principles of the invention with reference to a mold particularly suitable for use in making multi-material parts having optics such those found on headlamp covers or lens. Other embodiments suitable for other applications will be apparent to those skilled in the art given the benefit of this disclosure.

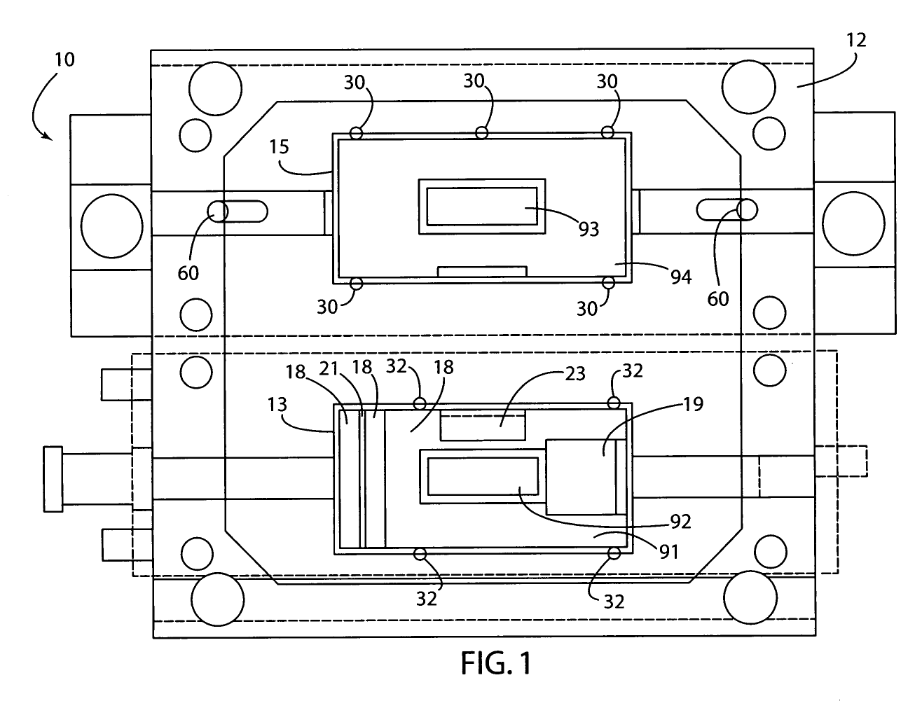

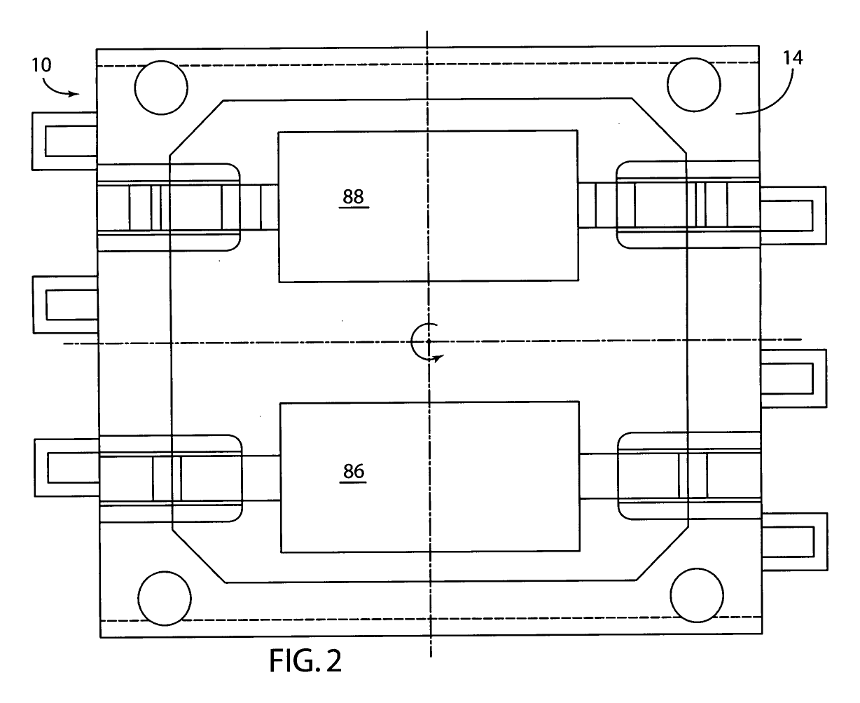

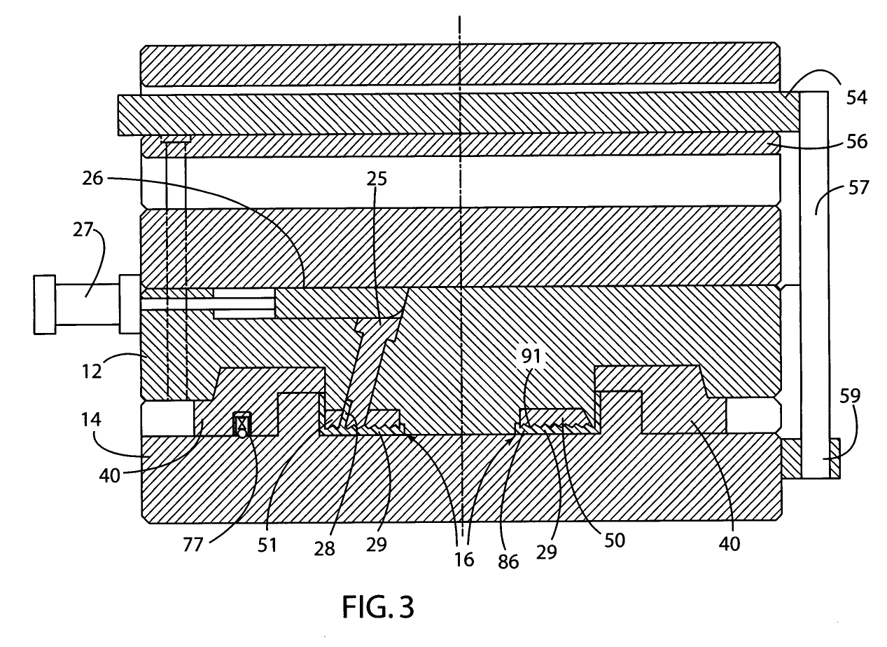

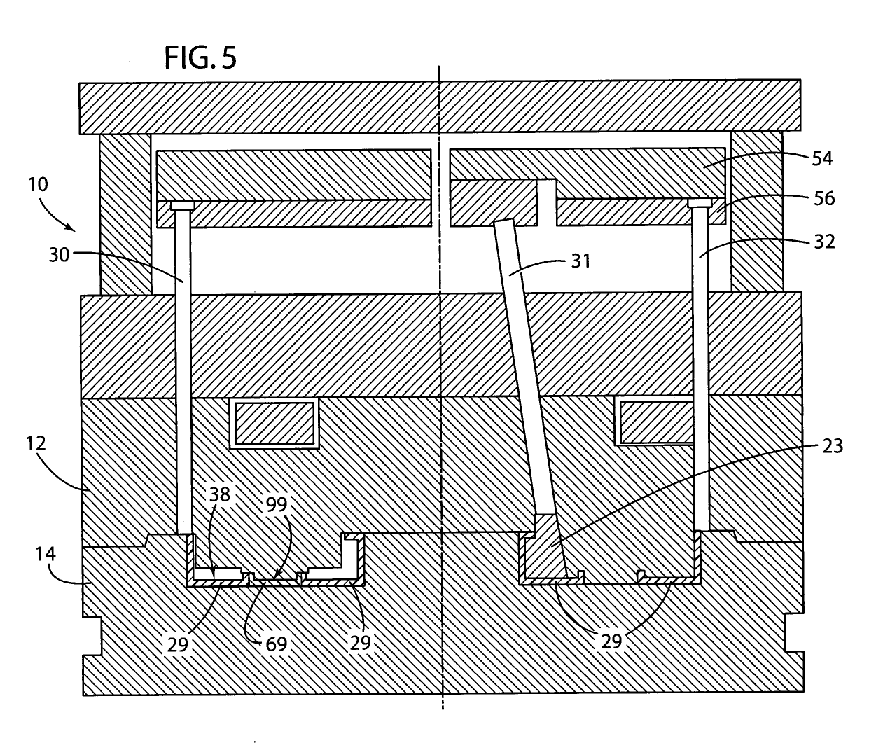

Referring now to the drawings, FIG. 1 shows a core half 12 of a two station multi-material mold 10 in accordance with a preferred embodiment. The core half 12 is preferably held stationary, and is shown having a first station 13 and a second station 15. FIG. 2 shows a cavity half 14. The stations cooperate with first and second surfaces 86, 88 of the cavity half 14 so that a first material is injected into the mold at the first station and a second material injected into the mold at the second station. Surface 91 of the core half defines part of a first mold cavity 16 (shown in FIG. 3). The first mold cavity is shown in the drawings as defined by several representative surfaces: a regular surface 21, and optical surfaces 18 and 19 and a PATENT surface of a lifter 23 (which may be also comprise an optical surface). A wide variety of optical surfaces and shapes may be used; the optical surfaces can be reflex surfaces, retroreflective surfaces, other optical surfaces (including fresnel, flute, pillow, etc.) or combinations of each, for example. Collectively the first mold cavity 16 is defined at station 13 by a core half surface 91 and slides 40 in combination with first surface 86 of the cavity half when the mold is closed (See FIG. 3). A latch mechanism 59 secured the mold halves together. The latch mechanism 59 is operatively connected to an ejector plate 56 via latch bar 57. The ejector plate is supported by ejector retainer plate 54. Preferably motion of a pin 32 (shown in FIG. 5) by the ejector plate 56 is slaved together with the separating of the mold halves, advantageously helping to secure a portion 29 of a part 99 to the cavity half as discussed below. A second surface 92 at first station 13 is not part of the first mold cavity. Other combinations of surfaces with varying optical properties will be readily apparent to those skilled in the art given the benefit of this disclosure.

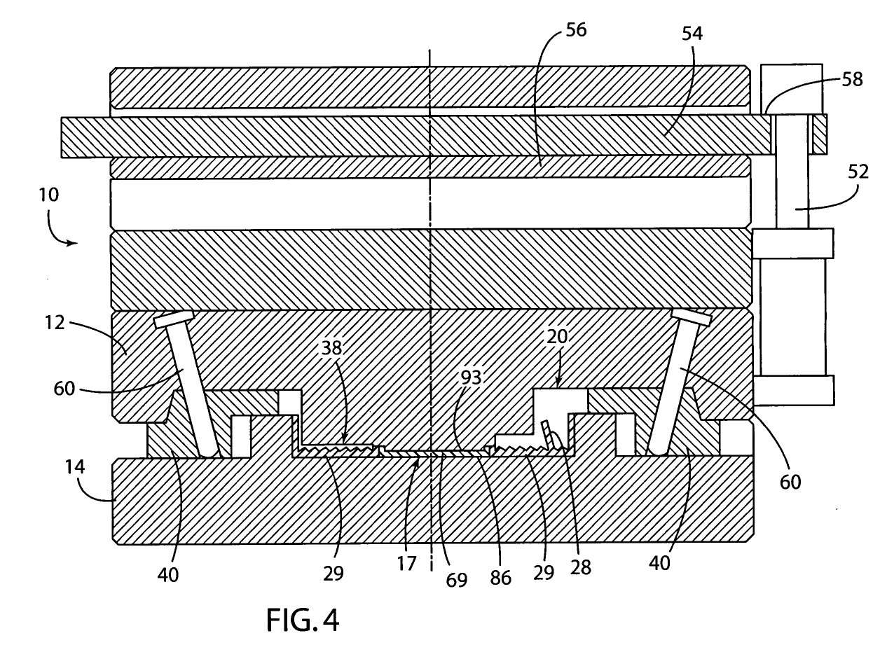

Advantageously, the second station 15 of the core half 12 is a mirror image of the first station 13 in terms of position of optical surfaces. That is, in accordance with a highly advantageous feature, no optical surfaces are present at the non-mating surface 94 which corresponds to the surface 91 on the first station 13. Optical surfaces, core pulls and lifters may be used at surface 93, but they are not necessary in this design. Mating surface 93 cooperates with the first surface 86 of cavity half and the first portion 29 of the part 99 to help define a second mold cavity 17 (seen in FIG. 4). The cavity half 14 of FIG. 2, has the first surface 86 where a first PATENT part is made, and a second surface 88 where a second part would be made. Cavity half surfaces 86 and 88 switch back and forth between the first station 13 and the second station 15 as the cavity half moves between a first closed position and a second closed position. Preferably, the cavity half 14 is rotatable about its center as shown in FIG. 2 between the first closed position and the second closed position. FIG. 3 shows the mold halves 12, 14 closed together with cavity half first surface 86 in the first closed position. The second closed position occurs after the mold 10 is opened (cavity half is pulled away from the core half), the cavity half rotates 180 degrees, and the mold is closed again so that first surface 86 is positioned generally adjacent surface 93 of the core half 12 (See FIG. 4). Pressurized cylinders and actuators (not shown) may be used to move the cavity half between these closed positions and open positions.

Ejector pins 32 (shown in FIGS. 1 and 5) may be used to help urge the portion 29 of the part 99 to stay with the cavity half 14 when the mold halves separate from the first station (See FIG. 5). A pair of slides 40 or other suitable mechanism is movable between an extended position as shown, and a retracted position. In the extended position the slides captivate the portion 29 formed from the first mold cavity, and keep it from separating from the cavity half as the cavity half moves from the first closed position to an open position and then to the second closed position. The slides 40 may be held in the extended position by any of a number of suitable devices, including for example a plunger 77. Electroforms 50, 51 are used in the preferred embodiment shown in the drawings. Also shown here is an optional core pull 25 to be used to help make an undercut 28. The core pull is moved by an actuator 26 and cylinder 27 after the first material is injected into the first mold cavity 16, while the mold is closed, and before the mold is opened, allowing the core pull 25 to move out of the way of the undercut 28 prior to moving the cavity half to the second station.

After the injection molding material (e.g. a polycarbonate resin) has been injection molded into the first mold cavity and the portion 29 formed is allowed to cool, the cavity half 14 is separated from the core half 12 and the portion 29 stays with the cavity half. The cavity half is then rotated about 180 degrees to the second station. As shown in FIG. 4, when the first portion 29 of the part 99 is at the second station, the non-mating surface 94 preferably does not contact the first mold cavity, as now occupied by the first portion 29; there is a clearance area 38. At the core half surface 94 adjacent clearance area 38 there is no need for optics, and no need for extensive polishing or finishing needed for mold surfaces that contact the injection molded material. Further, there is no need for lifters or core pulls at the second station merely because they are present (in certain preferred embodiments) at the first station.

Once the mold is closed at the second station, horn pins 60 or other similar devices may be used to urge the slides 40 away from portion 29 to a retracted position (See FIG. 4). The first portion 29 is seen to partially define the second mold cavity 17 (along with surfaces 86 and 93). A second material is injection molded into the second mold cavity. This second portion 69 in combination with first portion 29 completes the part 99.

The lifter 23 (shown in FIG. 5) is operatively connected by pin 31 to an ejector plate 54/ejector retainer plate 56 subassembly. Lifters as shown here are optional features which can be used instead of core pulls where the geometry of the part or the mold makes a core pull difficult to use. As the cavity half moves from the first closed position to an open position, the lifter is retracted, allowing the undercut to clear the lifter. A cylinder 52 abuts against a shoulder 58 to urge the lifter back to a position where it defines a first mold cavity as the mold is closed. FIG. 5 shows the first station on the right and the second station on the left. The lifter 23 cooperates with the surrounding componentry to define the first mold cavity. Ejector pins 30 are positioned at the second station 15 around the non-mating surface 94. When the mold opens after injecting the second material, the part 99 adheres to the core half due to surface geometry. The ejector pins 30 are used to eject a completed two-material part 99 from the mold 10.

In operation, the mold 10 is closed by clamping the cavity half 14 against the core half 12 at first station 13 with latch mechanism 59. The optical surfaces are on the fixed, core half 12 of the mold 10. The slides 40 are in the extended position, cooperating with surface 86 of the cavity half and surface 91 of the core half to define the first mold cavity 16. The slides are held in place by a plunger 77. In fact, the slides 40 preferably have nowhere to move at the first station 13. A molten material is injected into the first mold cavity 16. The gate location for the introduction of molten material will be readily apparent to those skilled in the art given the benefit of this disclosure. Electroforms 50, 51 forming one or more optical surfaces 18, 21 may be provided on the core half 12 at part or all of the first surface 91 that defines part of the first mold cavity 16. A second surface 92 of the core half is not part of the first mold cavity. The molten material is allowed to cure, forming a portion 29 of a part 99 to be made. Optionally the portion 29 may have an undercut 28 and the core pull 25 mounted on the core half 12 may be retracted prior to movement of the cavity half. A lifter 23 may be also used. Pin 31 mounted on the ejector plate 56 can retract and move the lifter 23 out of engagement with the part prior to rotation of the cavity half 14 to the second station. As shown in the drawings, both a core pull 25 and a lifter 23 may be used with the same part, depending on the desired aspects of the part.

After any core pull and lifters have been accounted for, the mold 10 is opened. Ejector pins 32 whose movement is coordinated with the opening of the mold urge the portion 29 of the part against the cavity half 14, and the slides 40 captivate the portion 29, helping to secure the portion to the cavity half as the cavity half rotates 180 degrees to the second closed position. The mold 10 is closed and the portion 29 is now at the second station 15. The act of closing the mold (moving the cavity half to the second closed position) urges cylinder 52 and ejector pins 30 back to their original position. Once the mold is closed, a second mold cavity 17 is formed. Second mold cavity is defined by previously formed portion 29, cooperating with first surface 86 of the cavity half and mating surface 93 of the core half to define the second mold cavity 16. The slides 40 do not define the second mold cavity. Now that they have served their task, the slides 40 are retracted by engagement of horn pins 60. The second material is shot into the second mold cavity 16, forming the second portion 69 of part 99. Once the material has cooled sufficiently, the mold is opened. This time, due to the geometry of the part and the lack of slides, the part 99 adheres to the core half 12 instead of the cavity half 14. Ejector pins 30 urge the part 99 out of the mold.

Advantageously, no duplicative electroform is required at the second station. Any electroform is required only if the second portion 69 requires optical components and even then, the electroform would not be required at the first station. Several variations in design will be readily apparent to those skilled in the art given the benefit of this disclosure. For example, more than two materials may be used, and additional stations supplied on each mold half as needed.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A multi-material mold comprising, in combination:
a core half having a first station and a second station with at least one optical surface on the first station;
a cavity half having a first surface, movable with respect to the core half between a first closed position and a second closed position; and
at least one slide attached to the cavity half, slidable between an extended position and a retracted position;
wherein the at least one slide cooperates with the first station of the core half and first surface of the cavity half to define a first mold cavity.

2. The multi-material mold of claim 1 wherein the second station of the core half and first surface of the cavity half cooperate to at least partially define a second mold cavity when the cavity half is in the second closed position.

3. The multi-material mold of claim 1 wherein a first portion of a part is formed in the first mold cavity and a second portion of the part is formed in a second mold cavity.

4. A multi-material mold comprising, in combination:
a core half having a first station and a second station;
at least one slide; and
a cavity half movable with respect to the core half between a first closed position wherein the at least one slide cooperates with the first station of the core half and the cavity half to define a first mold cavity adapted to form a portion of a part, and a second closed position wherein the portion of the part cooperates with the second station of the core half and the cavity half to define a second mold cavity;
wherein the at least one slide is slidable between an extended position adapted to hold the portion of the part formed in the first mold cavity to the cavity half, and a retracted position adapted to permit the part to exit the mold.

5. The multi-material mold of claim 4 wherein the first station comprises a first surface which defines the first mold cavity, and a second surface free of the first mold cavity.

6. The multi-material mold of claim 5 wherein the second station comprises a third surface which defines the second mold cavity, and a fourth surface free of the second mold cavity.

7. The multi-material mold of claim 6 wherein a clearance is provided between the portion of the part and the fourth surface when the cavity half is in the second position.

8. The multi-material mold of claim 4 wherein the cavity half is rotatable between the first closed position and the second closed position.

9. The multi-material mold of claim 4 wherein the second station of the core half further comprises a mating surface and a non-mating surface, and the mating surface cooperates with a first surface of the cavity half and the first portion of the part to define the second mold cavity.

10. The multi-material mold of claim 9 wherein a clearance exists between the non-mating surface and an area defined by the first mold cavity when the cavity half is in the second closed position.

11. A multi-material mold comprising, in combination:
a core half having a first station-and a second station;
at least one slide; and
a cavity half rotatable with respect to the core half between a first closed position wherein the at least one slide cooperates with the first station of the core half and the cavity half to define a first mold cavity, and a second closed position wherein the second station of the core half and the cavity half cooperate to at least partially define a second mold cavity;
wherein the at least one slide is slidable between an extended position adapted to hold a portion of a part formed in the first mold cavity to the cavity half, and a retracted position adapted to permit the part to exit the mold.

12. The multi-material mold of claim 11 wherein the first station of the core half has an optical surface and the second station does not have an optical surface.

13. The multi-material mold of claim 11 wherein the at least one slide is mounted on the cavity half.

14. The multi-material mold of claim 11 further comprising a core pull mounted on the core half which is retractable prior to movement of the cavity half from the first closed position to the second closed position.

15. The multi-material mold of claim 11 further comprising a lifter mounted on an ejector plate, wherein the lifter is retractable by the ejector plate in response to moving the cavity half from the first closed position to an open position.

16. The multi-material mold of claim 11 wherein a horn pin corresponding to each at least one slide urges the slide to move from the extended position to the retracted position.

17. The multi-material mold of claim 11 further comprising ejector pins mounted on the first station which help urge the portion of the part to remain on the cavity half when the cavity half moves from the first closed position to an open position.

18. The multi-material mold of claim 11 further comprising ejector pins mounted at the second station which eject the part from the mold after a second portion of the part is injection molded into the second mold cavity.

19. A method of making a multi-material part comprising in combination, the steps of:
closing a core half and a cavity half together;
moving at least one slide attached to the cavity half to an extended position;
injecting a first material into a first mold cavity defined by the core half, cavity half and the slide to form a first portion of the part;
separating the core half from the cavity half, with the first portion staying with the cavity half;
moving the cavity half with respect to the core half;
closing the core half and the cavity half together a second time; and
injecting a second material into a second mold cavity defined by the first portion of the part, the core half and the cavity half to form the multi-material part.

20. The method of claim 19 wherein the core half comprises a first station and a second station, wherein the first station defines part of the first mold cavity and the second station defines part of the second mold cavity.

21. The method of claim 20 further comprising
at least one electroform optical surface positioned on the core half.

22. The method of claim 21 wherein the at least one electroform surface is positioned only at the first station.

23. The method of claim 20 wherein one of a lifter and a core pull is positioned only at the first station.

24. The method of claim 19 further comprising moving the at least one slide to a retracted position after closing the core half and the cavity half together the second time.

25. The method of claim 19 wherein the step of moving the cavity half with respect to the core half comprises rotating the cavity half about 180 degrees.

26. The method of claim 19 further comprising the step of
separating the core half from the cavity half, with the multi-material part staying with the core half; and
ejecting the part from the core half.
